(19) United States
(12) Patent Application Publication
(10) Pub. No.: US 2018/0138836 A1
(43) Pub. Date: May 17, 2018

(54) VARIABLE SPEED DRIVE SYSTEM AND METHOD FOR STARTING AND/OR OPERATING A VARIABLE SPEED DRIVE SYSTEM

(71) Applicant: VOITH PATENT GMBH, Heidenheim (DE)

(72) Inventors: Bernd Lauter, Sontheim an der Brenz (DE); Jochen Lindenmaier, Herbrechtingen (DE)

(21) Appl. No.: 15/574,336

(22) PCT Filed: Apr. 27, 2016
(86) PCT No.: PCT/EP2016/059387

§ 371 Date: Nov. 15, 2017

(30) Foreign Application Priority Data
May 20, 2015 (DE) 10 2015 107 934.8

(51) Int. Cl. H02P 1/46; H02P 5/753

(52) U.S. Cl. CPC H02P 1/46; H02P 5/753

(57) ABSTRACT

A variable-speed drive system includes a driven machine mechanically coupled to a drive machine by a transmission unit. At least two regulating machines are mechanically coupled to the transmission unit and operated by at least two frequency converters. At least one of the at least two frequency converters is electrically connected to the drive machine by a changeover device, wherein a connection of the drive machine to at least one electric supply network is at least temporarily disconnectable to produce a controlled speed change on the drive machine.

### CROSS-REFERENCE TO RELATED PATENT APPLICATIONS

This patent application is a United States national phase patent application based on PCT/EP2016/059387 filed Apr. 27, 2016, which claims the benefit of German Patent Application No. DE 10 2015 107 934.8 filed May 20, 2015, the entire disclosures of which are hereby incorporated herein by reference.

### FIELD

The present invention relates to a variable-speed drive system.

### BACKGROUND

Variable speed drive systems are used in the industrial application in order to better adapt the power to be transferred to the respective process requirements. They are implemented in a variable-speed configuration especially in drive systems of compressors in the oil and gas industry, but also in fans of high power and in the drive of pumps in thermal power plants.

For example, a drive system is known from printed publication WO 2014/169302 A1, which has a speed-constant electric main drive, a rotor further as an output, a main transmission, which couples the drive and output, and a variable-speed drive, which is also coupled to the main transmission. The electric main drive can be started or run up by means of the speed-controllable drive. The speed-controllable drive is connected to a frequency converter, which can be switched to the main drive for start-up. As soon as the nominal speed of the electric main drive is reached, the electric main drive is switched to mains operation, and the speed-controllable drive is switched to the frequency converter for adjusting the output speed.

Furthermore, a differential system is known from WO 2011/000008 A1. The differential system consists of a differential stage, an adapting transmission stage and a differential drive. A rotor drives a main transmission, which is coupled to a synchronous generator by means of the differential stage. The differential drive is connected to an electric supply network via a frequency converter and a transformer. Likewise, WO 2011/000008 A1 discloses a switch which, by opening, easily disconnects the synchronous generator from the electric supply network.

A disadvantage of the solutions known from WO 2014/169302 A1 and WO 2011/000008 A1 is in particular the wear of the main transmission, which couples the drive to the output, wherein this wear is caused by the engagement of the speed-controllable drive or differential drive. It is further disadvantageous that during start-up of the main drive the speed-controllable drive or the differential drive cannot be controlled and must be mechanically braked or coupled. A further disadvantage is that the changeover between the speed-controllable drive or the differential drive and the main drive is not free from tractive-force interruptions.

### SUMMARY

Against the background of this problem, it is an object of the present invention to provide a variable-speed drive system of the type mentioned at the outset in which the wear occurring in the main transmission is kept as small as possible, that the speed-controllable drive or the differential drive can be controlled during the start-up of the main drive and in which, in particular, the changeover between the speed-controllable drive or the differential drive on the one hand and the main drive on the other hand is free from tractive-force interruptions. Furthermore, it is the object of the present invention to provide a method for starting up and/or operating such a variable-speed drive system.

These objects are achieved by the subject matter as shown and described herein.

Accordingly, a variable-speed drive system is proposed, which comprises a driven machine, a drive machine and at least two regulating machines. The drive machine is or can be mechanically coupled to the driven machine by means of a transmission unit. The at least two regulating machines, which are or can be mechanically coupled to the transmission unit, can be operated by means of one of at least two frequency converters. Furthermore, at least one of the at least two frequency converters is or can be electrically connected to the drive machine by means of a changeover device, such that a connection of the drive machine to at least one electric supply network can be temporarily or permanently disconnected in order to achieve a regulated and/or controlled speed change on the drive machine.

The advantages of the solution according to the invention are in particular that the wear occurring in the main transmission is kept as small as possible, that the speed-controllable drive or the differential drive can be controlled during the start-up of the main drive and that, in particular, the changeover between speed-controllable drive or the differential drive and the main drive is free from tractive-force interruptions.

This makes it possible to realise a variable-speed power transformer and at the same time a gentle drive motor starting device which achieves high efficiency levels in a very wide speed control range and uses the existing mechanical and electrical components optimally and economically for normal operation and starting operation. This variable-speed transmission with electrical power superimposition, intended for industrial applications in the preferred power range between 500 KW and 100 MW, achieves a very good availability for the reliable transmission components and electrical components from the low and medium voltage range and permits an energy-efficient start-up of the used drive machine.

In particular, the solution according to the invention offers a great advantage in applications in which a speed ratio is necessary for greater rotational speeds between the drive and the driven machine. Furthermore, it is particularly advantageous if the speed control of the driven machine need not be realised for the entire rotational speed range (instead 60-100% or 80-100%, for example). Under these conditions, the variable-speed drive system has a particularly advantageous and economical design.

In particular, in advantageous implementations of the solution according to the invention, it is provided that the at least two frequency converters are or can be electrically connected to the drive machine by means of the changeover device, such that the connection of the drive machine to the at least one electric supply network can be temporarily or permanently disconnected in order to obtain a regulated and/or controlled speed change on the drive machine. In other words, in contrast to the solutions known from the prior art and described above, a higher nominal power can be provided in the variable-speed drive system according to the invention for the control of the drive machine, for example by a parallel connection of at least two frequency converters. Furthermore, this embodiment allows a symmetrical engagement of the at least two regulating machines on the transmission unit and thus allows a simpler design of the sliding bearing in question for normal operation. The permanent symmetrical engagement via at least two speed-controllable drives has a positive effect on the cost and availability of the variable-speed drive system.

In an easy-to-implement but nevertheless effective further development, the changeover device has at least three switching devices, which are designed to electrically connect or disconnect the at least one frequency converter to or from one of the at least two regulating machines and/or the drive machine, and/or the drive machine to or from at least one of the electric supply networks. Accordingly, in the case of this embodiment, a changeover device is used for the variable-speed drive system, which, on the one hand, also fulfills the abovementioned advantages. On the other hand, however, the division of the required regulating powers between the electric regulating machines and their associated frequency converters can also be performed and optimised for different load characteristics of the working machine. Due to the at least three switching devices, the possibility of an energy-optimal load application to one or more electric regulating machines, which leads to an increase in the overall efficiency of the variable-speed drive system, is offered for the circuit.

In a further development, which is easy to implement but nevertheless effective, the changeover device has at least five switching devices, which are designed to electrically connect or disconnect the at least two frequency converters respectively to or from the at least two regulating machines and/or the drive machine, and/or the drive machine to or from at least one of the electric supply networks; and/or wherein the changeover device has at least two coupling elements, which are designed to couple the at least two frequency converters electrically. This further development also fulfills all the advantages of abovementioned embodiment. Furthermore, the energy-optimal load application to a plurality of electric regulating machines can be further optimised by means of the at least five switching devices, as a result of which the overall efficiency of the variable-speed drive system, as compared with the aforementioned exemplary embodiment, is further increased. Since the changeover device has at least two coupling elements, the timing and/or regulation of the at least two frequency converters can be further improved.

Alternatively or additionally, however, it is also conceivable for the variable-speed drive system to have a control device which is designed to set the driven machine into a reduced-load state by means of a bypass device. For example, in the case of variable-speed drive systems for compressors and pumps, a so-called bypass device or relief line can be used. For this purpose, the medium is fed via a line which establishes a connection between the suction side and the pressure side of the compressor/pump and leads from the pressure side back to the suction side. The connection can occur for example via stepped controllable or black/white valves. The return of the medium can preferably take place via a heat exchanger or cooler. The capacity and consequently the power consumption of the compressor or the pump can be varied by this measure. In multi-stage compressors, the bypass device can also take place between individual stages. For this task, so-called anti-surge valves can also be used in compressors, which in normal operation prevent an undesirable, back-directed flow of media from the pressure to suction side. During the start-up process of the variable-speed drive system, the compressed medium is fed back by these valves to the suction side. By additional shut-off valves on the suction feed line and/or pressure output line, a backward media flow, e.g. inside the pipeline, is prevented. Also during the start-up process of the variable-speed drive system, a control unit, which may be included in the variable-speed drive system, can signal a relief device, which can be coupled to the driven machine, to actuate the bypass device between the pressure and suction side and to prevent the backward flow of media. The resulting reduction in the load characteristic on the working machine allows the drive machine to start at nominal speed with a reduced electrical control power via the at least two frequency converters.

In a further embodiment, the mechanical coupling of the drive machine and the transmission unit can be disconnected by means of a clutch element, in particular by means of a mechanical or hydrodynamic clutch element. During the start-up process of the drive machine, this leads to a significant reduction in the load torque which has hitherto been impressed on the drive machine via the driven machine. The reduction of the load torque during the start-up process allows an optimal design of the provided nominal control power of the electric regulating machines and of the at least two frequency converters, in particular in the case of unfavourable load characteristics (constant torque or linear load torque over the rotational speed) of the driven machine or applications requiring only a very low speed control range of the output drive.

Furthermore, the respective mechanical couplings of the at least two regulating machines and of the transmission unit can preferably be separated by means of a respective clutch element, in particular by means of a mechanical or hydrodynamic clutch element. As in the aforementioned embodiment, a significant reduction in the load torque of the drive machine can also be produced here.

According to an alternative implementation of the changeover device, it is provided that it has a transformer. Through the interconnection of a transformer, voltage differences which exist in this way between the electric supply network and the at least two frequency converters can be omitted or compensated.

A method for starting up and/or operating a variable-speed drive system of the initially described type can at least comprise the following steps:
i) disconnecting all electrical connections, which can be produced by means of at least three switching devices having a changeover device;
ii) electrically connecting at least one of at least two frequency converters to a drive machine by switching an associated one of the at least three switching devices;
iii) impressing and/or triggering a regulated and/or controlled speed change on the drive machine by means of at least one of the at least two frequency converters on the drive machine;
iv) after reaching a predetermined rotational speed of the drive machine, disconnecting all electrical connections which can be produced by means of at least three switching devices having a changeover device; and
v) electrically connecting at least one of the at least two frequency converters to a respective regulating machine by switching an assigned one of the at least three switching devices, and electrically connecting the drive machine to an electric supply network by switching an associated one of the at least three switching devices.

A further method for starting up and/or operating a variable-speed drive system of the initially described type can at least comprise the following steps:
i) disconnecting all electrical connections, which can be produced by means of at least three switching devices having a changeover device;
ii) electrically connecting at least one of at least two frequency converters and/or the other of the at least two frequency converters to a drive machine by switching an assigned and/or another assigned one of the at least five switching devices;
iii) impressing and/or triggering a regulated and/or controlled speed change on the drive machine by means of at least two frequency converters and/or one of the at least two frequency converters on the drive machine;
iv) after reaching a predetermined rotational speed of the drive machine, disconnecting all electrical connections which can be produced by means of at least three switching devices having a changeover device; and
v) electrically connecting at least one of the at least two frequency converters to a respective regulating machine and/or another of the at least two frequency converters to another regulating machine by switching an assigned and/or another assigned one of the at least three switching devices and electrically connecting the drive machine to an electric supply network by switching an associated one of the at least three switching devices.

The same advantages apply to the two aforementioned methods as have already been described for the variable-speed drive system and its embodiments.

In a further method, the load characteristic of the driven machine can be set to a reduced load condition by means of a bypass device before the start-up process. After electrical connection of the drive machine to the electric supply network, the bypass device can cancel the relief and return it to the original load characteristic. The resulting reduction in the load characteristic on the working machine allows the drive machine to start up at nominal speed with a reduced electrical control power via the at least two frequency converters.

According to a further method, a mechanical coupling of the drive machine and a transmission unit can be separated before the start-up process by controlling a clutch element. After the electrical connection of the drive machine to the electric supply network, this mechanical coupling of the drive machine and the transmission unit can be reconnected by controlling the clutch element. During the start-up process of the drive machine, this leads to a significant reduction in the load torque which has hitherto been impressed on the drive machine via the driven machine. The reduction of the load torque during the start-up process allows an optimal design of the provided nominal control power of the electric regulating machines and of the at least two frequency converters, in particular in the case of unfavorable load characteristics (constant torque or linear load torque over the rotational speed) of the driven machine or applications which only require a very low speed control range of the driven machine.

### BRIEF DESCRIPTION OF THE DRAWINGS

Two exemplary embodiments of the variable-speed drive system according to the invention are described below with reference to the accompanying drawings, wherein:

FIG. 1: shows a schematic representation of a first exemplary embodiment of the variable-speed drive system according to the invention;

FIG. 2: shows a mechanical design of the coupling of two regulating machines 2.1, 2.2 with a transmission unit 17 and, coupled therewith, a drive machine 1 and a driven machine 3 of the first exemplary embodiment of the variable-speed drive system according to the invention according to FIG. 1;

FIG. 3: shows an electrical circuit diagram of a further, second exemplary embodiment of the variable-speed drive system according to the invention; and

FIG. 4: shows an electrical circuit diagram of the first embodiment of the variable-speed drive system according to the invention shown in FIG. 1.

### DETAILED DESCRIPTION OF THE EMBODIMENTS

Only those elements which are essential for the direct understanding of the invention are shown.

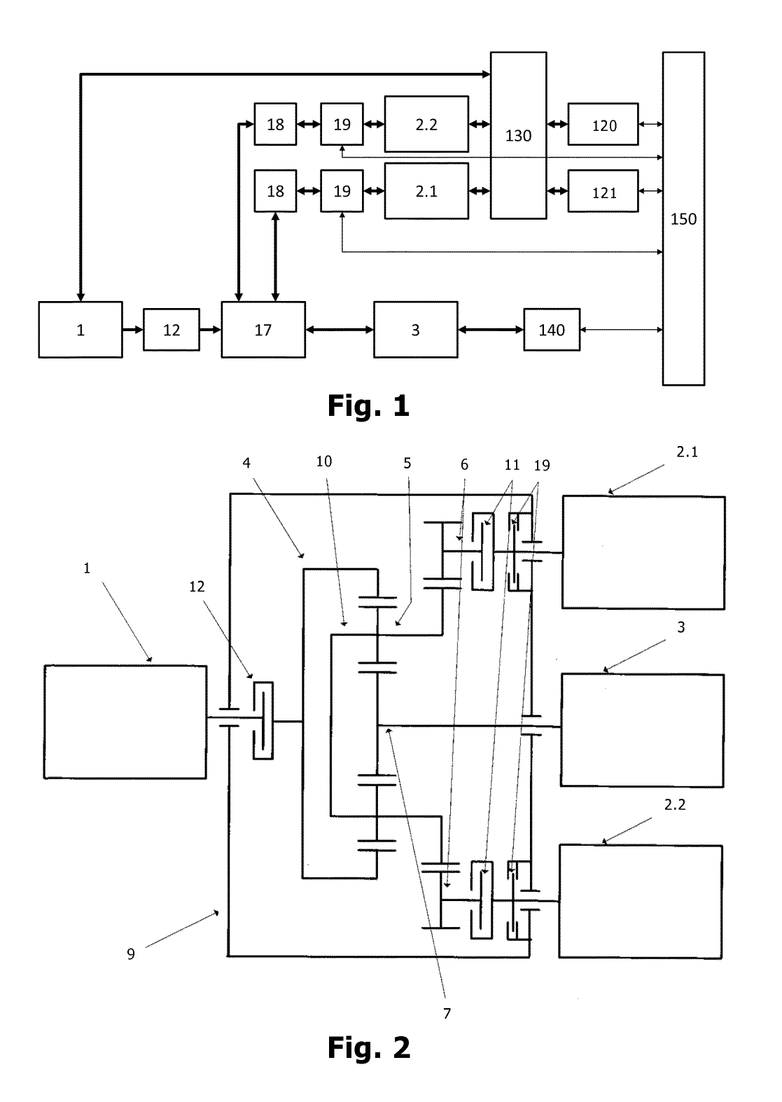

The schematic illustration of a variable-speed drive system indicated in FIG. 1 shows a transmission unit 17 with a central input shaft on a drive machine 1, such as an electric induction machine, and with a central output shaft on a driven machine 3.

The transmission unit 17 is preferably designed as a planetary gear which has a sun gear 7, a planet carrier 10 with planetary gears 5 (also referred to as “planets” in the following) and a ring gear 4. Thus, coaxiality between the input (drive) and output (driven) shaft is realized.

Two regulating machines 2.1, 2.2 are coupled to the transmission unit 17 via respective transmission stages 18 of a branch, and can thus feed power into the drive machine 1. The two regulating machines 2.1, 2.2 may be independent speed-controllable electric motors.

The connection of the input and output shaft to the planetary gear can take place in different ways, thus differentiating the different types of superposition gears.

The planets 5 in the planetary gear set provide a coupling possibility for a superimposed branch. The following types of planetary gear units are possible:

| Form | Drive | Output | Superimposition |
|---|---|---|---|
| A | Ring gear 4 | Planet carrier 10 | Sun gear 7 |
| B | Sun gear 7 | Planet carrier 10 | Ring gear 4 |
| C | Sun gear 7 | Ring gear 4 | Planet carrier 10 |
| D | Planet carrier 10 | Ring gear 4 | Sun gear 7 |
| E | Planet carrier 10 | Sun gear 7 | Ring gear 4 |
| F | Ring gear 4 | Sun gear 7 | Planet carrier 10 |

The selection of a suitable transmission variant is dependent on the respective requirement profile of the working machine in terms of torque and rotational speed and available, suitable drive machines 1 for the power superimposition.

The two regulating machines 2.1, 2.2 can be braked and/or released with a respective braking unit 19. The braking units 19 are arranged within the variable-speed drive system in FIGS. 1 and 2. An alternative embodiment would be to arrange the braking units 19 outside the variable-speed drive system. Furthermore, the independently controllable regulating machines 2.1, 2.2 can be decoupled from the transmission unit 17 by means of suitable separating devices (clutch devices 11) in the respective transmission stage 18.

By braking and/or releasing the regulating machines 2.1, 2.2 by respective braking units 19, this can be used in normal operation in order to tightly brake the speed of the control path to 0 (zero) rpm. During the start-up process, the braking units 19 can be used to apply a defined load on the respective regulating machine 2.1, 2.2 in the case of unfavourable distribution of the mass inertias between the drive machine 1, regulating machines 2.1, 2.2 and output machine 3, which leads to a defined division of the input and output rotational speeds of the transmission unit 17.

In normal operation, the regulating machines 2.1, 2.2 are electrically connected via a changeover device 130 to a respective frequency converter 120, 121. The regulating machines 2.1, 2.2 are operated with varying speed by means of the respective frequency converters 120, 121 in normal operation.

The control and regulation commands required for the starting process and normal operation are generated by the control unit 150. The control unit is implemented as an independent component. However, it can also be arranged integrated within at least one of the frequency converters 120, 121 or within the changeover device 130. The control unit 150 generates necessary control commands during the starting process, and reads back the implemented switching states within the changeover device 130 and plausibilises the switching requirements and switching states with respect to one another and controls or regulates their temporal sequences. The control unit 150 has at least control accesses to the frequency converters 120, 121, the clutch device 11 within the transmission unit 17, a relief device 140 on the driven machine 3, and the braking units 19.

The relief device 140 on the driven machine 3 can be designed as an inlet guide valve (for compressors or fans) or as a bypass device (for pumps) depending on the design of the driven machine 3. The relief device 140 performs a change in the load characteristic of the driven machine 3 to lower loads.

A clutch element 12, which is interposed between the drive machine 1 and the transmission unit 17, offers the possibility of interrupting the mechanical coupling between the electric drive machine 1 and the ring gear 4, which represents the connection to the transmission unit 17. During the start-up process of the drive machine 1, this leads to a significant reduction in the load torque which has previously been impressed on the drive machine 1 via the driven machine 3.

The reduction of the load torque during the start-up process allows an optimal design of the provided nominal control power of the electric regulating machines 2.1, 2.2 and the frequency converter 120, 121, in particular in the case of unfavourable load characteristics (constant torque or linear load torque over the rotational speed) of the driven machine 3 or in applications, which require a very low speed control range of the driven machine 3. During the start-up process with the variable-speed drive system according to the invention, the braking devices 19 are not used and can thus optionally be omitted.

The mechanical design shown in FIG. 2 shows the connection of the drive shaft (drive machine 1) to the ring gear 4 of the planetary gear. The output shaft on the driven machine 3 is connected to the sun gear 7 of the planetary gear. The planets 5 are mounted in the planet carrier 10. The planet carrier 10 is driven via two spur gear stages 6 by two variable-speed electric motors, i.e. the regulating machines 2.1, 2.2. The clutches 11 serve to separate the electric regulating machines 2.1, 2.2 from the respective spur gear stages 6. The braking devices 19 allow the drive shaft of the regulating machines 2.1, 2.2 to be directly or indirectly fixed or released in relation to a transmission housing 9.

The gear ratio of the planetary gear system

$${i}_{0 - UG} = \frac{{z}_{Ho - UG}}{{z}_{So - UG}} = \frac{{n}_{a - nenn} \times {U}_{pkt}}{{n}_{e}}$$

results from the number of teeth of the planetary gearing, or by the selection of the reversing point and the required nominal output rotational speed and the driving rotational speed. The speed ratio between the planetary carrier 10 and the rotor speed of the regulating machines 2.1, 2.2 is determined with the standard gear ratio.

The use of a plurality of electric regulating machines 2.1, 2.2 has a number of advantages for the starting process of the electric drive machine 1 and for the normal operation of the variable-speed drive system. A symmetrical arrangement of the mechanical engagement via the spur gear stages 6 of the electric regulating machines 2.1, 2.2 permits an optimal force introduction into the planet carrier 10 and its mounting can be formed more cost-effectively. Furthermore, the use of at least two electric regulating machines 2.1, 2.2 offers the possibility of a functional redundancy with a possibly restricted speed operating range.

Within the starting process, additional regulating machines 2.1, 2.2 allow an operating state in which the impressed load can be reduced by the rotating driven machine 3. By means of an actively impressed load during the starting process, the braking devices 19 may possibly be dispensed with.

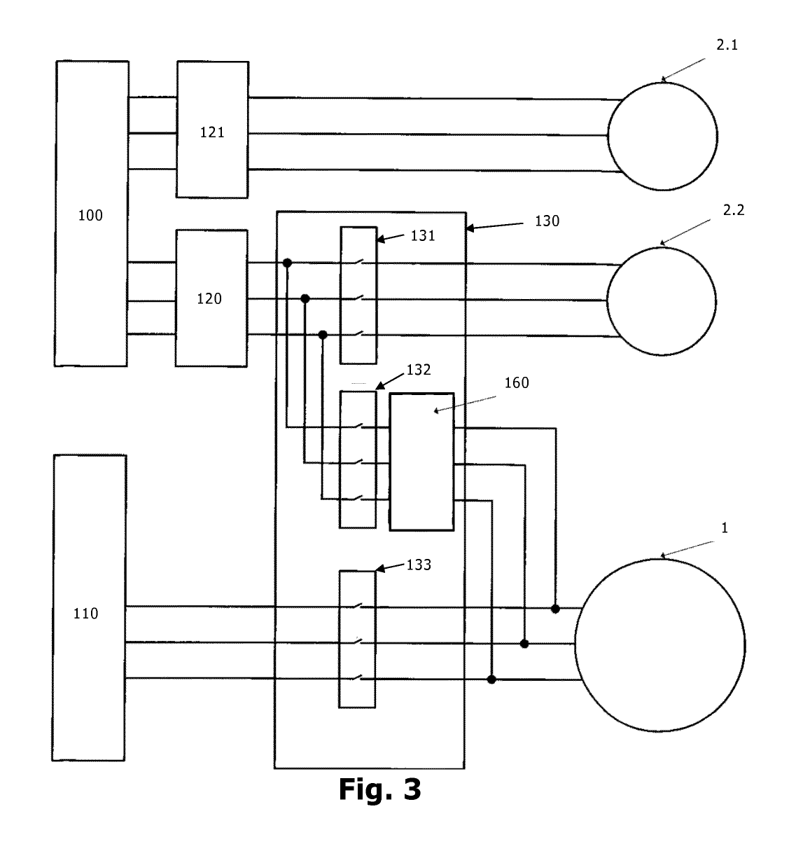

The electrical circuit diagram shown in FIG. 3 relates to a second exemplary embodiment of the variable-speed drive system according to the invention. It comprises the electric supply network 100, two frequency converters 120, 121 and their associated electric regulating machines 2.1, 2.2. The operating level of the electric supply network 100 depends on the required nominal power of the electric regulating machines 2.1, 2.2 and their number and the required starting power which the variable-speed drive system must realise in the electric drive machine 1 during the starting process. Favorable rated voltages of the frequency converters 120, 121 and of the regulating machines 2.1, 2.2 are between 400V to 13.8 KV. Furthermore, the variable-speed drive system has the electric supply network 110, which is or can be coupled to the electric drive machine 1 via the changeover device 130. The required voltage level of the electric supply system 110 depends on the required nominal power of the electric drive machine 1 and the existing available voltage supplies 100, 110. Favorable rated voltages of the electric drive machine 1 are in the medium voltage range between 1 KV to 50 KV. The two frequency converters 120, 121 serve to vary the voltage level and the frequency from the electric supply network 100. The first frequency converter 120 allows the speed-controlled operation of the second electric regulating machine 2.2 or of the electric drive machine 1 as a function of the changeover device 130. The second frequency converter 121 permits the speed-controlled operation of the first electric regulating machine 2.1. The changeover device 130 has three switching devices 131, 132, 133 and the associated electrical cabling and connection possibilities. The first and third switching device 131, 133 can also be realized and provided outside the changeover device 130, depending on the application. A superordinate control and interlocking of the individual switching devices 131, 132, 133 is ensured by the changeover device 130 and its control unit 150 (not shown in FIG. 3). Within the changeover device 130, elements (not shown in the drawings) can be integrated, which protect the electrical components and cables and protect these components from exceeding or falling below the permissible threshold values in current and voltage.

The electrical run-up of the drive machine 1 is made possible by the variable-speed drive system using the two frequency converters 120, 121, in particular as electromechanical start-up assistance, and the two regulating machines 120, 121.

A first method for starting up and/or operating the variable-speed drive system is described below. Before the starting process, the electric drive machine 1, the driven machine 3 and the two electric regulating machines 2.1, 2.2 are at a speed close to 0 (zero) rpm or significantly below the nominal speed. The changeover device 130 produces the following electrical connections via the first three switching devices 131, 132, 133 before the run-up or start-up:
The first switching device 131 interrupts the electrical connection between the first frequency converter 120 and the second electric regulating machine 2.2.
The second switching device 132 interrupts the electrical connection between the first frequency converter 120 and the electric drive machine 1.
The third switching device 133 interrupts the electrical connection between the first electric supply network 110 and the electric drive machine 1.

If the run-up of the electric drive machine 1 is to be carried out, the changeover device 130 produces the following electrical connections via the three switching devices 131, 132, 133:
The first switching device 131 interrupts the electrical connection between the first frequency converter 120 and the second electric regulating machine 2.2.
The second switching device 132 establishes the electrical connection between the first frequency converter 120 and the electric drive machine 1.
The third switching device 133 interrupts the electrical connection between the first electric supply network 110 and the electric drive machine 1.

The electrical connection between the first frequency converter 120 and the electric drive machine 1 allows operating the drive machine 1 at a variable frequency and a variable voltage between 0 (zero) volts and the rated voltage of the first frequency converter 120 and its electric supply network 100 at a varying speed.

The nominal power of the first frequency converter 120, which is defined by its nominal voltage and its nominal current, can be increased during the starting process for a defined time range which is determined mainly by the thermal load of the power semiconductor by a current flow greater than the nominal current. The nominal power of the first frequency converter 120 is determined by the respective design of the starting device and is typically 10-40% of the total output power. If, owing to the design, a different rated voltage of the electric drive machine 1 with the rated voltage U_{NENN} and the first frequency converter 120 with the rated voltage U_{VFD} should occur, it should be taken into account that the maximum torque, which can be generated during the start-up of the electric drive machine 1, decreases with increasing speed. The maximum torque, which can be reached at the nominal speed of the electric drive machine 1 is in this case

$${M}_{start \cdot ma x} = {M}_{nenn} \tilde{A} - {( \frac{{U}_{VFD}}{{U}_{nenn}} )}^{2} .$$

The adaptation of the rated voltages can take place via a transformer 160. In this case, the limitation in the maximum achievable torque is omitted.

The electric drive machine 1 increases its speed during the further course of the method; the second electric regulating machine 2.2 is not actively triggered, but variable rotational speeds can be impressed on the planetary carrier 10 via the spur gear stage 6 by means of the first electric regulating machine 2.1 via its second frequency converter 121. As a result of the mechanical coupling between the electric drive machine 1 via the transmission unit 17 to the driven machine 3, there is likewise a speed increase on the driven machine 3. This speed increase of the driven machine 3 can be reduced or increased via the first electric regulating machine 2.1. The increase or reduction corresponds to the functional principle, which is used in the normal operation for the variation of the output speed. During the start-up of the drive machine 1, the driven machine 3, for a defined rotational speed range of the drive machine 1, is held at speeds close to 0 (zero) rpm by means of the first variable-speed electric regulating machine 2.1. This measure makes it possible to reduce a resulting load moment caused by a rotating driven machine 3. The mechanical design of the variable-speed drive system, the first electric regulating machine 2.1, and in particular the transmission unit 17, defines the speed range of the drive machine 1 in which the rotational speed of the driven machine 3 can be reduced. It also defines which speed is impressed on the driven machine 3 when the drive machine 1 is operated at the nominal speed and the first electric regulating machine 2.1 impresses a maximum reduction of the output speed. The braking device 19 is not used in this starting method and can be omitted or has to release the drive shaft of the two regulating machines 2.1, 2.2 during this starting process.

Depending on the load characteristic (e.g. parabolic, constant, falling or increasing) of the driven machine 3 and the output speed, different loads are impressed which are overcome by the first frequency converter 120 via the drive machine 1 in order to accelerate the driven machine 3 to the nominal rotational speed. An adaptation of the load characteristic of the driven machine 3 can be achieved via the control unit 150 by means of activation of a relief device 140 if required.

The electromechanical start-up assistance by means of the first frequency converter 121 and its assigned second regulating machine 2.1 allows an optimal distribution of the required total regulating power of the two frequency converters 120, 121, so that more regulating power is provided for the first frequency converter 120 or the second frequency converter 121 as a function of the load characteristic.

After the drive machine 1 has reached a rotational speed close to the nominal rotational speed (+/−5%) the drive machine 1 can be connected without any problems to the second supply network 110. Depending on the design of the drive machine 1, the differential rotational speed (slip) and/or the phase position between the drive machine 1 and the supply network 110 must be taken into account. In this case, the control unit 150 checks these relationships and the switching devices 131, 132, 133 of the changeover device 130 switch only when the required conditions are fulfilled.

In this case, the changeover device 130 produces the following electrical connections via the three switching devices 131, 132, 133:
The first switching device 131 interrupts the electrical connection between the first frequency converter 120 and the second electric regulating machine 2.2.
The second switching device 132 interrupts the electrical connection between the first frequency converter 120 and the electric drive machine 1.
The third switching device 133 interrupts the electrical connection between the first electric supply network 110 and the electric drive machine 1.

After ensuring that there is no further direct or indirect connection between the first electric supply network 100 and the electric drive machine 1, the changeover device 130 establishes the following electrical connections:
The first switching device 131 produces the electrical connection between the first frequency converter 120 and the second electric regulating machine 2.2.
The second switching device 132 interrupts the electrical connection between the first frequency converter 120 and the electric drive machine 1.
The third switching device 133 establishes the electrical connection between the second electric supply network 110 and the electric drive machine 1.

This switching state of the changeover device 130 corresponds to the usual switching state in the normal operation of the variable-speed drive system and leads to an operation of the drive machine 1 with an almost constant speed defined by the frequency of the second electric supply network 110 and the construction of the winding system of the drive machine 1. During normal operation, the braking device 19 can be used to fix the planet carrier 10 and therefore set a constant speed at the so-called reversal point. The braking device 19 can also be used to release the drive shaft of the electric regulating machines 2.1, 2.2 in order to influence the output speed of the driven machine 3 via the rotational speed of the electric regulating machines 2.1, 2.2.

For this purpose, the braking device 19 is influenced via the control unit 150. The frequency converters 120, 121 are used to operate the respectively assigned electric regulating machines 2.1, 2.2 with varying speed and to thereby set a varying speed on the driven machine 3.

By influencing the torques and rotational speeds of the two regulating machines 2.1, 2.2, the torque-speed characteristic of the entire transmission can be designed. The torque-speed characteristic can be implemented by the electric regulating machines 2.1, 2.2 by using two electric regulating machines 2.1, 2.2 and clutch devices 11, wherein flexibility is achieved in the division between the individual regulating machines 2.1, 2.2. In order to increase the efficiency and availability to the overall device, individual regulating machines 2.1, 2.2 can be operated without control by the respective frequency converter 120, 121 and/or decoupled from the spur gear stage 6 by the associated clutch devices 11.

An increase in efficiency can be produced by a higher degree of component efficiency of the electric regulating machines 2.1, 2.2 during operating conditions with power requirements close to the nominal power. Furthermore, drag and friction losses can be reduced by decoupling by means of associated clutch devices 11.

The increase in availability is achieved by interrupting the electrical connection between the regulating machines 2.1, 2.2 and their associated frequency converters 120, 121 by means of the changeover device 130 and the assigned three switching devices 131, 132, 133. A reaction of electrical malfunctions, which occur in the electric regulating machines 2.1, 2.2 and/or the associated frequency converters 120, 121, can be suppressed thereby.

Mechanical errors such as the blocking on the electric regulating machines 2.1, 2.2 for example can be achieved by a decoupling by means of associated clutch devices 11.

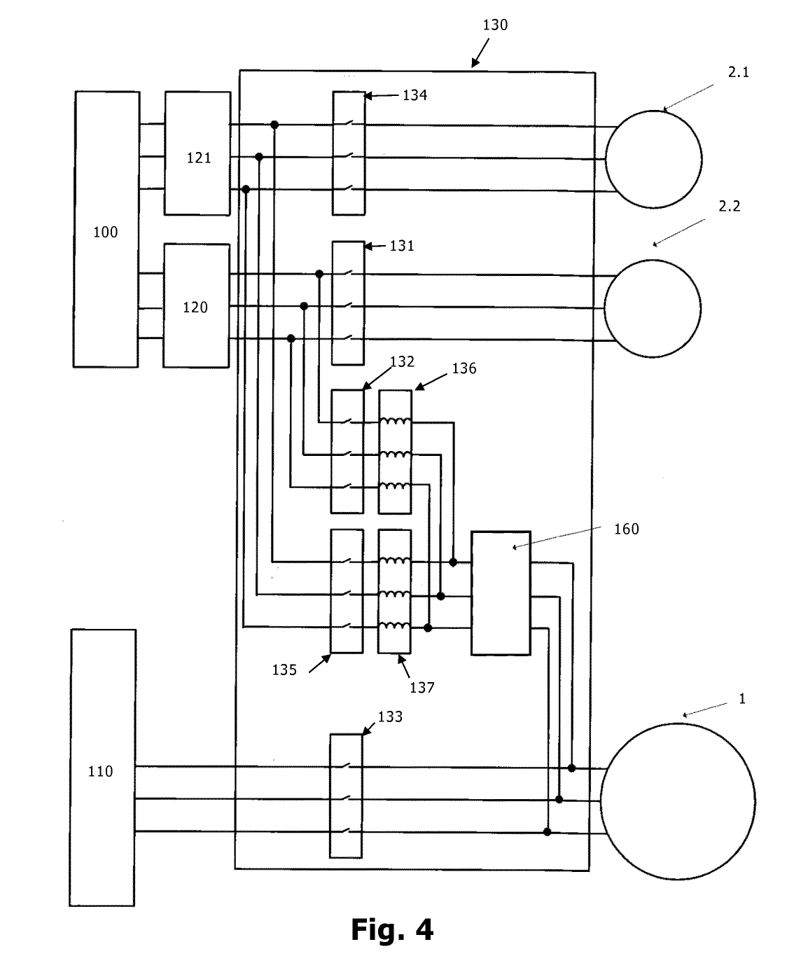

FIG. 4 shows an electrical circuit diagram according to the first exemplary embodiment of the variable-speed drive system according to the invention shown in FIG. 1. It comprises the electric supply network 100, two frequency converters 120, 121 and their associated electric regulating machines 2.1, 2.2. The voltage level of the electric supply system 100 is based on the required nominal power of the electric regulating machines 2.1, 2.2, and their number and the required starting power that needs to be realised by the variable-speed drive system in the electric drive machine 1 during start-up. Favorable rated voltages of the frequency converters 120, 121 and the regulating machines 2.1, 2.2 are between 400V to 13.8 KV. Furthermore, the variable-speed drive system comprises the electric supply network 110 that is or can be coupled via the changeover device 130 to the electric drive machine 1. The required voltage level of the electric supply network 110 depends on the required nominal power of the electric drive machine 1 and the existing available voltage supplies 100, 110. Favorable rated voltages of the electric drive machine 1 are in the medium voltage range between 1 KV to 50 KV. The two frequency converters 120, 121 serve to vary the voltage level and the frequency from the electric supply network 100. The first frequency converter 120 permits the speed-controlled operation of the second electric regulating machine 2.2 or the electric drive machine 1 as a function of the changeover device 130. The second frequency converter 121 permits the speed-controlled operation of the first electric regulating machine 2.1 or the electric drive machine 1 as a function of the changeover device 130. The changeover device 130 has five switching devices 131, 132, 133, 134, 135, two electrical coupling elements 136, 137 and the associated electrical cabling and connection possibilities. The first, third and fourth switching device 131, 133, 134 can also be realised and provided outside the changeover device 130, depending on the application. A superordinate control and interlocking of the individual switching devices 131, 132, 133, 134, 135 is ensured by the changeover device 130 and its control unit 150 (not shown in FIG. 4). Within the changeover device 130, elements (not shown in the drawings) can be integrated, which protect the electrical components and cables and protect these components from exceeding or falling below the permissible threshold values in current and voltage. The coupling elements 136, 137, which may be embodied as inductances, allow the two frequency converters 120, 121 to be electrically coupled. The necessity and design of the coupling elements 136, 137 is decisively defined by the category, type and switching characteristics of the five switching devices 131, 132, 133, 134, 135 (so-called power semiconductors) of the frequency converters 120, 121.

Within the starting process, the two electric frequency converters 120, 121 are electrically coupled by means of the changeover device 130 and are used in a parallel connection in order to start the electric drive machine 1.

Within the changeover device 130, the first and fourth electrical switching device 131, 134 are actuated with an identical control state to enable an electrical disconnection or connection between the electric regulating machines 2.1, 2.2 and the respectively assigned frequency converters 120, 121. The second and fifth switching device 132, 135 are actuated with an identical control state in order to enable an electrical disconnection or connection (parallel connection) between the two frequency converters 120, 121 and the drive machine 1.

The embodiment of the variable-speed drive system shown in FIG. 4 is preferably used if the advantages regarding the efficiency and availability of two or more electric regulating machines 2.1, 2.2 with a purely electrical start-up of the drive machine 1 without electro-mechanical relief should be carried out via the regulating machines 2.1, 2.2. In this case, a higher nominal power is available for controlling the drive machine 1 by the parallel connection of two frequency converters 120, 121. Furthermore, this embodiment permits a symmetrical engagement of the regulating machines on the corresponding element of the planetary gear, thereby permitting a simpler design of the concerning sliding bearing for normal operation. The permanent symmetrical engagement via the two variable-speed regulating machines 2.1, 2.2 has a positive effect on the cost and availability of the arrangement.

The invention is not limited to the exemplary embodiments shown in the drawings of the variable-speed drive system according to the invention, but is a summary of all features disclosed herein.

### LIST OF REFERENCE NUMERALS

1 Drive machine
2.1 First regulating machine
2.2 Second regulating machine
3 Driven machine
4 Ring gear
5 Planets
6 Spur gear stage
7 Sun gear
9 Transmission housing
10 Planet carrier
11 Clutch device
12 Clutch element
17 Transmission unit
18 Transmission stage
19 Braking unit
100 First electric supply network
110 Second electric supply network
120 First frequency converter
121 Second frequency converter
130 Changeover device
131 First switching device
132 Second switching device
133 Third switching device
134 Fourth switching device
135 Fifth switching device
136 First electrical coupling element
137 Second electrical coupling element
140 Relief device
150 Control unit
160 Transformer

1-12. (canceled)

13. A variable speed drive system, comprising:
a driven machine;
a drive machine which is or can be mechanically coupled to the driven machine by a transmission unit; and
at least two regulating machines which are or can be mechanically coupled to the transmission unit and can each be operated by one of at least two frequency converters, wherein at least one of the at least two frequency converters is electrically connected or connectable to the drive machine by a changeover device, wherein a connection of the drive machine to at least one electric supply network can be disconnected at least temporarily or permanently to generate a regulated and/or controlled speed change on the drive machine.

14. The variable-speed drive system according to claim 13, wherein the at least two frequency converters are electrically connected or connectable to the drive machine by the changeover device.

15. The variable-speed drive system according to claim 13, wherein the changeover device further comprises at least three switching devices configured to electrically connect or disconnect the at least one of the at least two frequency converters to the at least two regulating machines and/or the drive machine, and/or the drive machine to the at least one electric supply network.

16. The variable-speed drive system according to claim 13, wherein the changeover device further comprises at least five switching devices configured to electrically connect or disconnect the at least two frequency converters to respective ones of the at least two regulating machines and/or the drive machine, and/or the drive machine to the at least one electric supply network; and/or wherein the changeover device comprises at least two coupling elements adapted to electrically couple the at least two frequency converters.

17. The variable-speed drive system according to claim 13, further comprising a control device to set the driven machine to a reduced load state by a bypass device.

18. The variable-speed drive system according to claim 13, wherein a mechanical coupling of the drive machine and a transmission unit are separable by a clutch element, wherein the clutch element is a mechanical clutch element or a hydrodynamic clutch element.

19. The variable-speed drive system according to claim 13, wherein respective mechanical couplings of the at least two regulating machines and the transmission unit are separable by a respective clutch element, wherein the clutch element is a mechanical clutch element or a hydrodynamic clutch element.

20. The variable-speed drive system according to claim 13, wherein the changeover device further comprises a transformer.

21. A method of starting up and/or operating the variable-speed drive system according to claim 13, the method comprising steps of:
i) disconnecting all electrical connections, which can be produced by at least three switching devices having the changeover device;
ii) electrically connecting at least one of the at least two frequency converters to the drive machine by switching an associated one of the at least three switching devices;
iii) impressing and/or controlling the regulated and/or controlled speed change in the drive machine by the at least one of the at least two frequency converters on the drive machine;
iv) after reaching a predetermined rotational speed of the drive machine, disconnecting all electrical connections which can be produced by the at least three switching devices having the changeover device; and
v) electrically connecting at least one of the at least two frequency converters to a respective one of the at least two regulating machines by switching an associated one of the at least three switching devices and electrically connecting the drive machine to the at least one electric supply network by switching an associated one of the at least three switching devices.

22. The method according to claim 21, wherein an original load characteristic of the driven machine is brought to a reduced load state by a bypass device before a start-up process, and after electrical connection of the drive machine to the at least one electric supply network, the bypass device cancels a relief and switches back to the original load characteristic.

23. The method according to claim 21, wherein a mechanical coupling of the drive machine and the transmission unit is separated by a clutch element before a start-up process and after electrical connection of the drive machine to the at least one electric supply network, and wherein the mechanical coupling of the drive machine and the transmission unit is reconnected by the clutch element.

24. A method of starting up and/or operating the variable-speed drive system according to claim 13, the method comprising steps of:
i) disconnecting all electrical connections, which can be produced by at least five switching devices having the changeover device;
ii) electrically connecting at least one of the at least two frequency converters to the drive machine by switching an associated one of the at least five switching devices;
iii) impressing and/or controlling the regulated and/or controlled speed change in the drive machine by the at least two frequency converters and/or at least one of the at least two frequency converters on the drive machine;
iv) after reaching a predetermined rotational speed of the drive machine, disconnecting all electrical connections which can be produced by the at least five switching devices having the changeover device; and
v) electrically connecting at least one of the at least two frequency converters to a respective one of the at least two regulating machines by switching an associated switching device of the at least five switching devices and electrically connecting the drive machine to the at least one electric supply network by switching an associated one of the at least five switching devices.

25. The method according to claim 24, wherein an original load characteristic of the driven machine is brought to a reduced load state by a bypass device before a start-up process, and after electrical connection of the drive machine to the at least one electric supply network, the bypass device cancels a relief and switches back to the original load characteristic.

26. The method according to claim 24, wherein a mechanical coupling of the drive machine and the transmission unit is separated by a clutch element before a start-up process and after electrical connection of the drive machine to the at least one electric supply network, and wherein the mechanical coupling of the drive machine and the transmission unit is reconnected by the clutch element.
